(19) United States
(12) Patent Application Publication
(10) Pub. No.: US 2015/0081342 A1
(43) Pub. Date: Mar. 19, 2015

(54) SYSTEM AND METHOD TO FACILITATE INSURANCE WORKFLOW IMPROVEMENTS

(71) Applicants: Nicholas A. Dawson, Casselberry, FL (US); Matthew J. Donzella, Windsor, CT (US); Elizabeth A. Dreier, Newington, CT (US); Matthew Thomas Kern, Noblesville, IN (US); Deidre M. Hernandez, Glastonbury, CT (US); Ryan Kyle McKain, West Hartford, CT (US); Matthew S. Sandberg, Hebron, CT (US)

(72) Inventors: Nicholas A. Dawson, Casselberry, FL (US); Matthew J. Donzella, Windsor, CT (US); Elizabeth A. Dreier, Newington, CT (US); Matthew Thomas Kern, Noblesville, IN (US); Deidre M. Hernandez, Glastonbury, CT (US); Ryan Kyle McKain, West Hartford, CT (US); Matthew S. Sandberg, Hebron, CT (US)

(21) Appl. No.: 14/030,129

(22) Filed: Sep. 18, 2013

(51) Int. Cl. G06Q 10/06

(52) U.S. Cl. CPC G06Q 10/0633; G06Q 40/08
USPC 705/4

(57) ABSTRACT

According to some embodiments, an indication of a suggested improvement to an insurance workflow may be received from a submitter's remote insurance processing terminal. A manager associated with the submitter may be automatically identified, and a message may be transmitted to the identified manager, the message including an identification of the submitter and information about the suggested improvement. Supplemental information associated with the suggested improvement may then be received from the manager and stored at a central workflow improvement platform along with the identification of the submitter and the indication of the suggested improvement. The indication of the suggested improvement and the supplemental information may then be automatically forwarded to one or more members comprising a suggestion review council. According to some embodiments, a potential sponsor for the suggested improvement may also be identified.

### BACKGROUND

A claim professional working for an insurer may help process an insurance claim. For example, the claim professional might make a telephone call to discuss insurance coverage with a claimant and create a note in a claim file (e.g., an electronic record associated with the claim) that this step has been performed. Note that an insurance claim may be associated with a series of processing steps (e.g., a coverage determination, a liability assessment, a damages calculation, and an ultimate resolution) comprising a workflow. Moreover, a claim professional may notice potential improvement as he or she processes insurance claims. For example, a claim professional might realize that two similar steps could be combined into a single step to save time. It can be difficult, however, for an insurer to make use of such realizations in an efficient manner, especially when a relatively large number of claim professionals and/or processing locations are involved. In addition, the processing of insurance claims and other types of insurance activities may involve tens of thousands individual items and a large number of insurance entity employees, which can make even relatively minor improvements to an insurance workflow important. Moreover, different organizations within the insurer may have different workflows and/or different priorities with respect to implementing improvements. This can make it even more difficult to determine which potential improvements should be implemented by the insurer. It would therefore be desirable to provide systems and methods to facilitate insurance workflow improvements in an automated, efficient, and consistent manner.

### SUMMARY OF THE INVENTION

According to some embodiments, systems, methods, apparatus, computer program code and means may provide a tool to facilitate insurance workflow improvements. In some embodiments, an indication of a suggested improvement to an insurance workflow may be received from a submitter's remote insurance claim processing terminal. A manager associated with the submitter may be automatically identified, and a message may be transmitted to the identified manager, the message including an identification of the submitter and information about the suggested improvement. Supplemental information associated with the suggested improvement may then be received from the manager and stored at a central workflow improvement platform along with the identification of the submitter and the indication of the suggested improvement. The indication of the suggested improvement and the supplemental information may then be automatically forwarded to one or more members comprising a suggestion review council. According to some embodiments, a potential sponsor for the suggested improvement may also be identified.

A technical effect of some embodiments of the invention is an improved and computerized method to facilitate insurance workflow improvements. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates an insurance workflow improvement process according to some embodiments.

FIG. 3 illustrates a method that might be performed in accordance with some embodiments.

FIG. 4 illustrates an insurance workflow improvement submission interface according to some embodiments of the present invention.

FIG. 5 illustrates a submission view interface according to some embodiments of the present invention.

FIG. 6 illustrates a submission interface according to some embodiments of the present invention.

FIG. 7 illustrates a schedule for innovation counsel review interface according to some embodiments of the present invention.

FIG. 8 illustrates a submitted improvement interface according to some embodiments of the present invention.

FIG. 9 illustrates an insurance workflow improvement process according to some embodiments of the present invention.

FIG. 10 illustrates an insurance workflow improvement dashboard interface according to some embodiments of the present invention.

FIG. 11 illustrates an interface for a mobile device according to some embodiments of the present invention.

FIG. 12 illustrates an insurance workflow improvement process according to some embodiments of the present invention.

FIG. 13 is block diagram of an insurance workflow improvement tool or platform according to some embodiments of the present invention.

FIG. 14 is a tabular portion of a submitted workflow improvement database according to some embodiments.

### DESCRIPTION

An insurance professional working for an insurer may help process an insurance claim, make underwriting decisions, etc. For example, a claim professional might send a letter to a claimant a pre-determined number of days after a claim is filed. Note that an insurance claim may be associated with a series of such processing steps (e.g., a coverage determination, a liability assessment, a damages calculation, and an ultimate resolution) comprising an insurance workflow. Moreover, a claim professional may notice a potential improvement as he or she processes insurance claims. For example, a claim professional might detect that a particular telephone prompt tends to confuse claimants. It can be difficult, however, for an insurer to make use of such realizations in an efficient manner, especially when a relatively large number of insurance items, claim professionals and/or processing locations are involved.

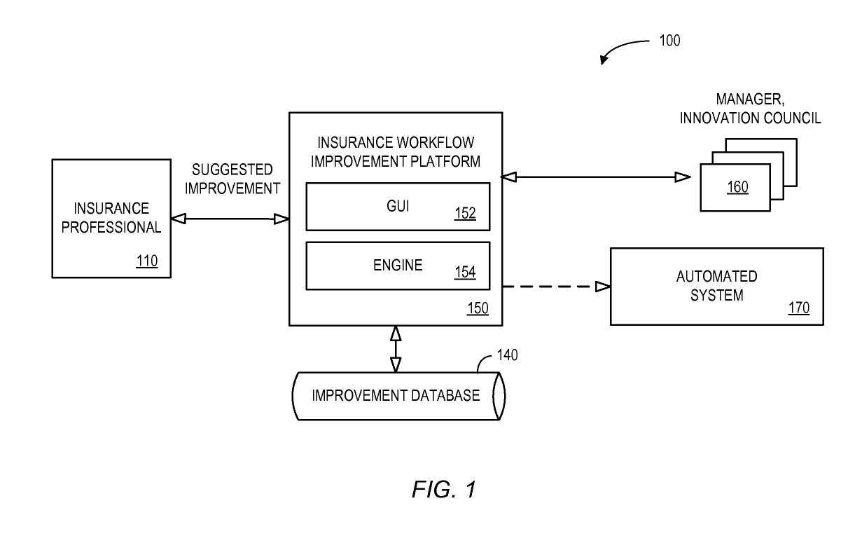

It would therefore be desirable to provide systems and methods to facilitate insurance workflow improvements in an automated, efficient, and consistent manner. FIG. 1 is block diagram of a system 100 according to some embodiments of the present invention. In particular, the system 100 includes an insurance workflow improvement platform 150 that receives automobile insurance claim data from an insurance professional 110. According to some embodiments, the insurance workflow improvement platform 150 may also receive information, such as an electronic file, from a client, an employee, or insurance agent. The insurance professional 110, such as a claim handler, may transmit to the insurance workflow improvement platform 150 information about a suggest improvement to an insurance workflow which may then be stored in an improvement database 140. The insurance workflow improvement platform 150 might be, for example, associated with a Personal Computers (PC), laptop computer, an enterprise server, a server farm, and/or a database or similar storage devices. The insurance workflow improvement platform 150 may, according to some embodiments, be associated with a business organization or an insurance provider.

According to some embodiments, an “automated” insurance workflow improvement platform 150 may facilitate insurance claim workflow improvements using a Graphical User Interface (“GUI”) 152. As used herein, the term “automated” may refer to, for example, actions that can be performed with little or no human intervention. The insurance professional 110 may interact with the graphical user interface 152 to submit a suggested insurance workflow improvement and information about the suggestion may be provided to other parties 160, such as a manager or members of an innovation council. According to some embodiments, an engine 154 may facilitate the processing of a suggested improvement. The insurance workflow improvement platform 150 might also transmit information to an external automated system 170, such as a report generator, workflow application, or email notification system.

As used herein, devices, including those associated with the insurance workflow improvement platform 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The insurance workflow improvement platform 150 may store information into and/or retrieve information from the improvement database 140. The improvement database 140 may be locally stored or reside remote from the insurance workflow improvement platform 150. Although a single insurance workflow improvement platform 150 is shown in FIG. 1, any number of such devices may be included. Moreover, various devices described herein might be combined according to embodiments of the present invention. For example, in some embodiments, the claim insurance workflow improvement platform 150 and improvement database 140 might be co-located and/or may comprise a single apparatus.

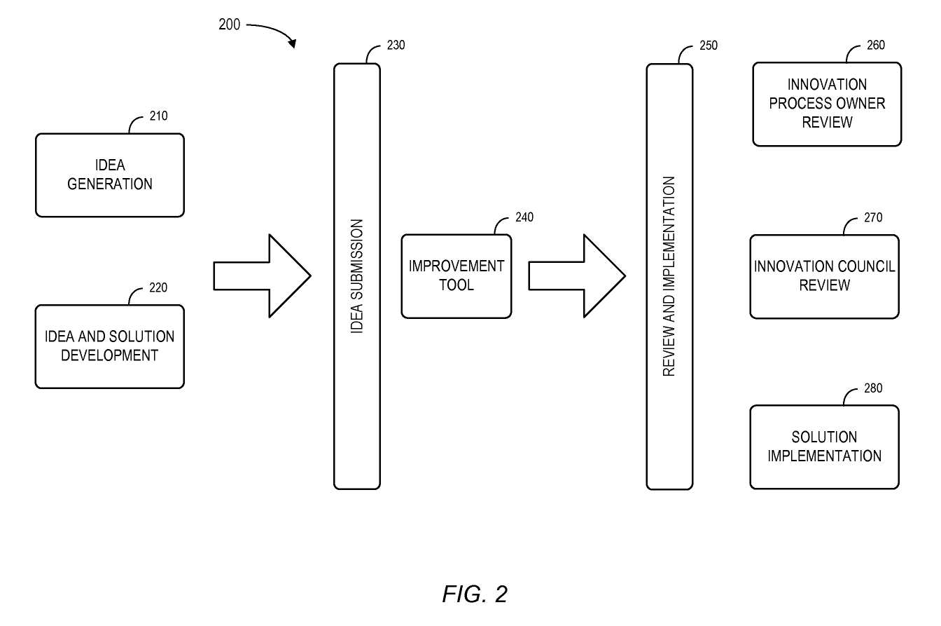

The elements of the system 100 may be used to implement a workflow improvement program. For example, FIG. 2 illustrates an insurance workflow improvement program or process 200 according to some embodiments. The process begins with the generation of an idea 210 to improve insurance workflow. For example, a claim professional might identify an opportunity to update Medicare data more efficiently. The idea and solution may also undergo further development 220 with a fast track handler and/or a team leader to map out details and describe the solution.

The idea may be submitted 230 to an improvement tool 240 that will facilitate review and implementation 250 of the idea. In particular, an innovation process owner review 260 may finalize development of the idea/solution to present to an innovation council for review 270. The innovation council may approve and prioritize ideas and the process 200 may then conclude with implementation of the solution 280.

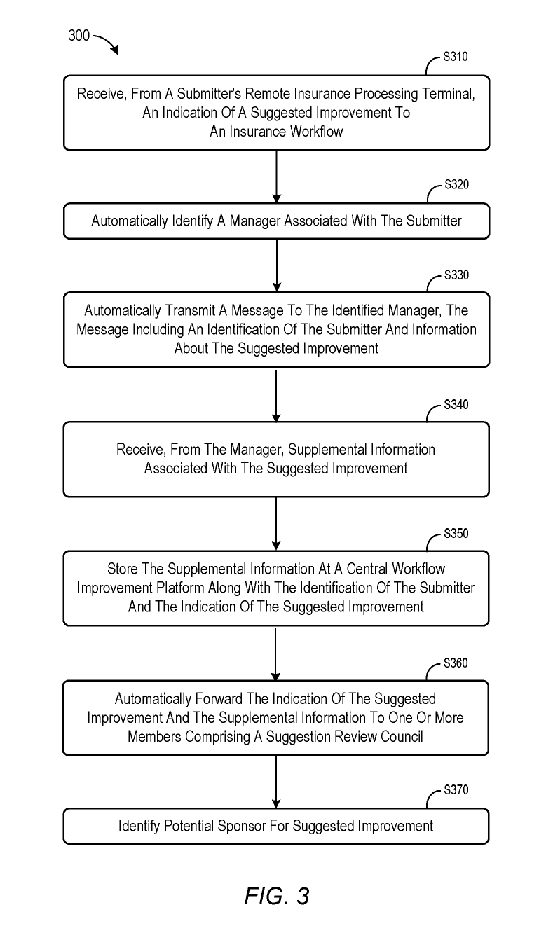

FIG. 3 illustrates a method that might be performed by some or all of the elements of the system 100 described with respect to FIG. 1 and/or the process 200 of FIG. 2. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a communication device may receive, from a submitter's remote insurance processing terminal, an indication of a suggested improvement to an insurance workflow. The received indication of a suggested improvement to the insurance workflow might, for example, include one or more of: (i) an explanation of opportunity, (ii) an estimated impact of problem, (iii) a proposed solution, (iv) a primary improvement area, (v) an indication of involved individuals, (vi) a site, and (vii) a remote worker indication.

At S320, a manager associated with the submitter may be automatically identified. For example, an employee identifier of the submitter may be used to look up the manager's identifier in an employee database. As used herein, the term “manager” may refer to any person or entity that may provide additional information about a suggestion, including a boss, team leader, or supervisor. At S330, a message may be automatically transmitted to the identified manager, the message including an identification of the submitter and information about the suggested improvement. For example, an email message might be transmitted to the manager, and the email message might include a link that, when activated by the manager, causes a display of a workflow improvement application.

At S340, supplemental information associated with the suggested improvement may be received from the manager. For example, the manager might indicate whether or not he or she thinks the suggested improvement is feasible. At S350, the supplemental information may be stored at a central workflow improvement platform along with the identification of the submitter and the indication of the suggested improvement. Note that, according to some embodiments, the submitter is able to access a first portion of the supplemental information without being able to access a second portion (e.g., the information submitted by his or her manager). Such an approach may, for example, encourage a manager to provide honest feedback about a suggested improvement.

According to some embodiments, a process owner may be assigned to the suggested improvement. The process owner might, for example, provide one or more of: (i) a benefits calculation, (ii) a review date, (iii) an implementation date, (vi) a date of decline, (vii) action item descriptions, (viii) a sponsor identifier, (ix) a business lead, (x) a claims organization selection, (xi) a field department selection, (xii) a status, (xiii) a reason for closing, and (xiv) recognitions (e.g., recognizing and/or rewarding the submitter).

At S360, the indication of the suggested improvement and the supplemental information may be automatically forwarded or routed to a plurality of members comprising a suggestion review council. After the suggestion review council considers the suggested improvement (along with other improvements), an indication of approval (or disapproval) may be received from the suggestion review council. If approved, the insurance workflow may then be adjusted in accordance with the suggested improvement. According to some embodiments, this process might include identifying a potential sponsor at S370 for the suggested improvement. As used herein, the term “sponsor” might refer to any person or entity who may help implement and/or pay for the suggested improvement. Some embodiments further comprise retrieving the supplemental information at the central workflow improvement platform along with the identification of the submitter the indication of the suggested improvement, and transmitting the indication of the suggested improvement and the supplemental information to the sponsor. The sponsor may, for example, oversee and/or fund implementation of an approved suggestion.

According to some embodiment, a plurality of submitted improvements may be automatically analyzed to identify potentially related submitted improvements. For example, the analysis may look for redundant suggested improvements, categorized suggested improvements, and/or alternate suggested improvements (e.g., two different ways to solve the same problem in the insurance claim workflow).

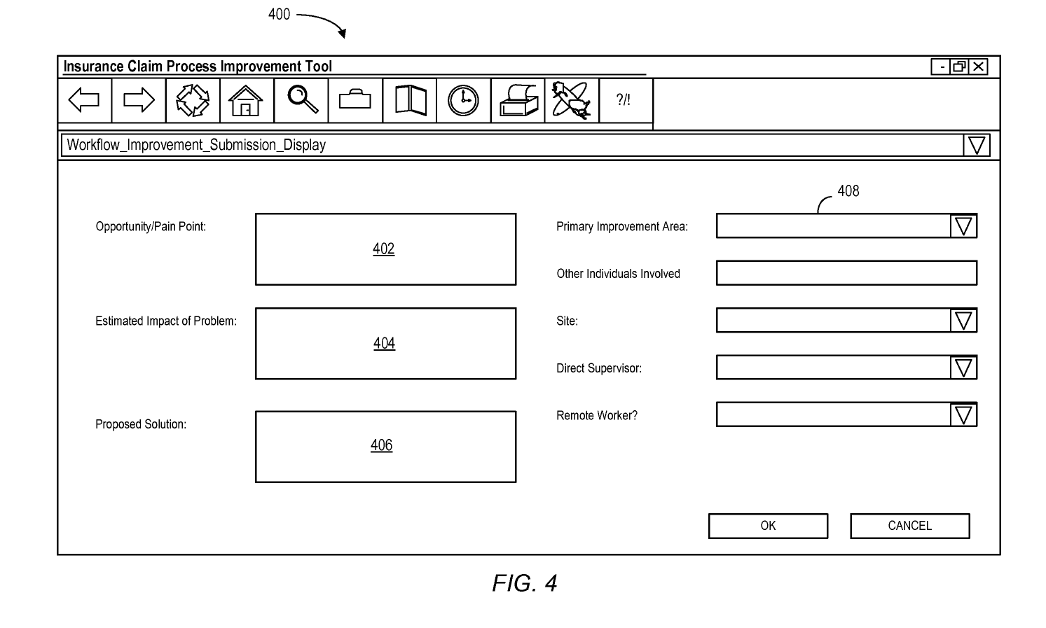

Some or all of the steps in improvement process may be implemented via one or more GUIs. For example, FIG. 4 illustrates an insurance workflow improvement submission interface 400 according to some embodiments of the present invention. The interface 400 includes an opportunity text input area 402 that may be used by a claim professional to define the problem he or she is trying to solve. The interface 400 may also include an estimate impact of problem text input area 404 that may be used to explain the scope of the problem (e.g., the problem causes a 30 minute delay in the processing of 2% of all claims that are received). A proposed solution text input area 406 may be used to define how the problem should be solved (e.g., an additional question should be included in a questionnaire given to claimants). The interface might further include selections 408 associated with the primary improvement area, other individuals that are involved, a site (e.g., a claims processing site in Tennessee), a supervisor, and/or whether or not a remote worker is involved. When the information is completed, the claims professional may select “OK” to submit the suggestion or cancel to stop the process.

Such an approach may engage and empower claim professionals in the process of identifying problems and developing and contributing to solutions. The best ideas may come from the people who execute a workflow on a daily basis and therefore have experience and insight that maybe key to finding lasting, sustainable improvements for an insurance organization.

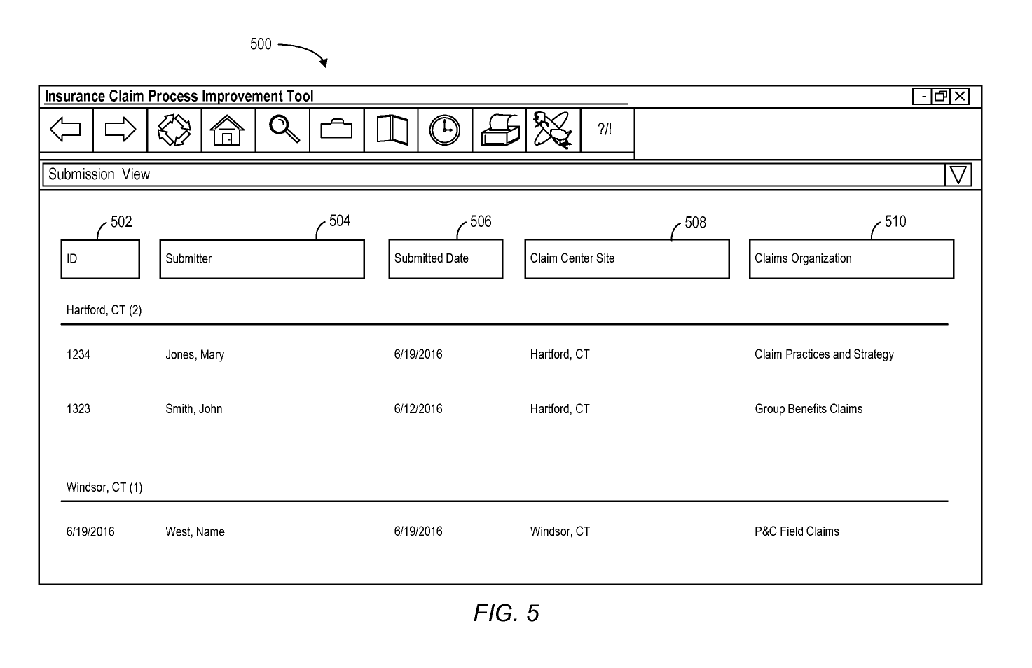

Since a relatively large number of suggestions might be received from a substantial number of claim professionals, some embodiments provide for the generation and/or display a report associated with a plurality of suggested improvements based at least in part on: (i) suggested improvement status, (ii) claims site, (iii) line of business, (iv) submitter, (v) date, and/or (vi) importance. For example, FIG. 5 illustrates one example of a submission view interface 500 according to some embodiments of the present invention. In this case, a claim professional, manager, promoter, sponsor, etc. might view submissions based on identifier 502, submitter 504, submission date 506, claim center site 508, and/or claims organization 510 (e.g., group benefits claims or automobile claims).

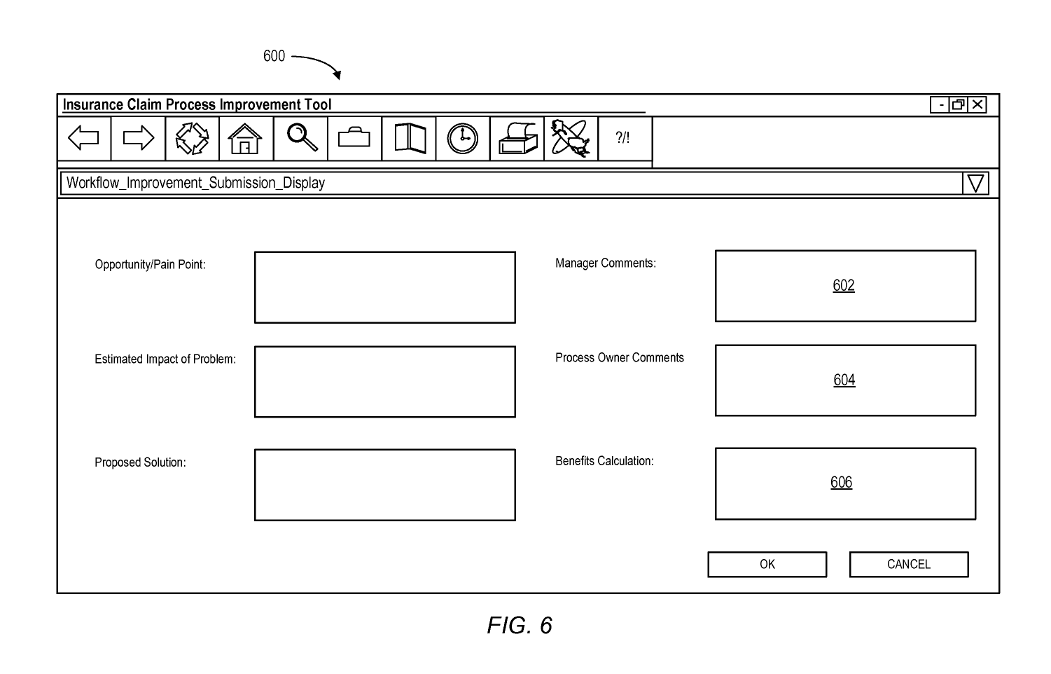

After a claim professional submits a suggested improvement, a manager or process owner may provide additional information about the idea. For example, FIG. 6 illustrates a submission interface 600 according to some embodiments of the present invention. Such a display 600 might be provided, for example, in an automatic email asking for manager comments 602, process owner comments 604, and/or a benefits calculation 606 (e.g., the idea will take few resources to implement and will result in substantial quality improvements).

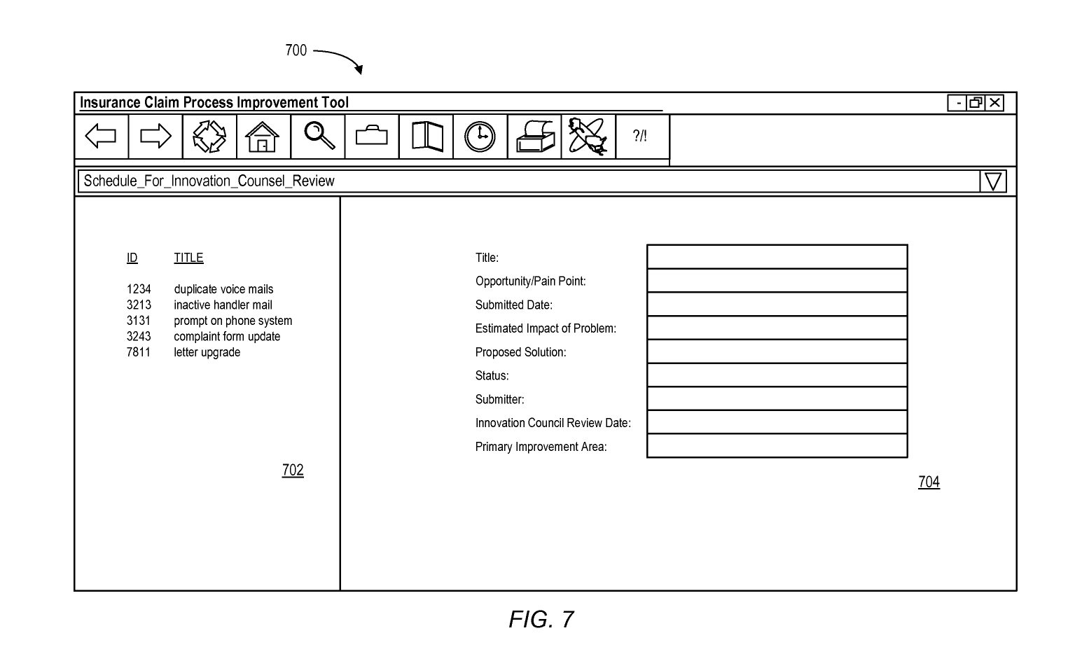

After an initial review is complement by a manager and/or process owner, the submission may be schedule to be reviewed by an innovation council. For example, FIG. 7 illustrates a schedule for innovation counsel review interface 700 according to some embodiments of the present invention. A first area 702 of the interface 700 may list multiple submitted ideas (e.g., an identifier and title). When one of the ideas is selected, a second area 704 of the interface 700 may be used to enter an innovation council review date. At this point, an indication of the review date might be automatically transmitted to the submitter in an email.

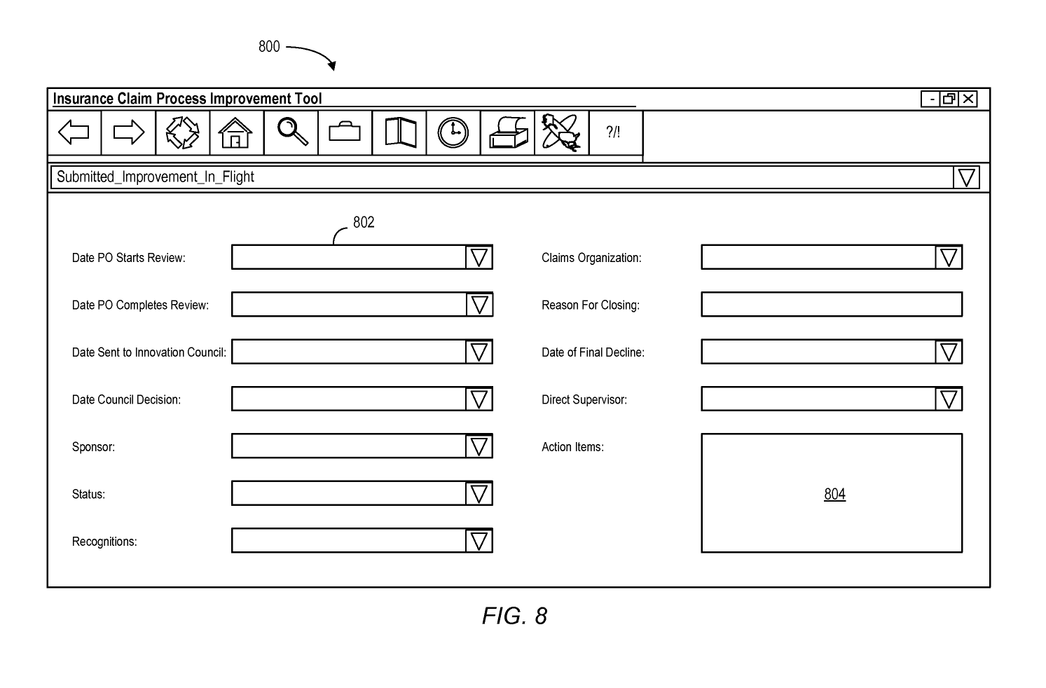

During the review process, a sponsor may be assigned, the council might approve or decline submission, and FIG. 8 illustrates a submitted improvement interface 800 that may be used to track information about a submitted idea according to some embodiments of the present invention. In particular, the interface 800 includes selections 802 indicating the date a process owner began to review the idea, the date of a council decision, the current status, whether or not the submitter has be recognized and/or rewarded, etc. The interface 800 also includes a text input area 804 that may be used to keep tract of action items associated with the submitted idea (e.g., contact the Information Technology group to determine if the submitted idea can even be implemented).

The interface 800 of FIG. 8, or any of the other interfaces described herein, may be used to search for previously submitted improvements. For example, someone considering entering a new idea or a potential sponsor might search a database to locate submissions using keywords, tags, categories, and other advanced search features to text, video, audio, and other types of data associated with his or her search.

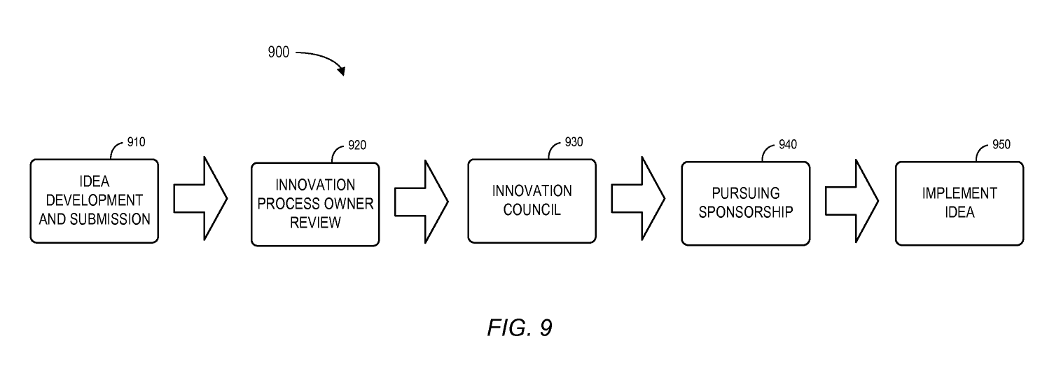

FIG. 9 illustrates an insurance workflow improvement process 900 according to some embodiments of the present invention. During idea development and submission 910, an employee may identify an opportunity, measure the impacts, hypothesize a solution or root cause, engage his or her manager and/or site champion for feedback, and eventually submit the idea in accordance with any of the embodiments described here. During innovation process owner review 920, a manager may review the submission and provide comments to determine if this is a unique opportunity (not a duplicate idea) and has the necessary detail to be brought forward to the innovation committee for review. In some cases, the manager might ask the original submitted to provide additional details about the problem and/or solution.

The innovation council 930 may review the submission during a bi-weekly meeting to determine if the submission should move forward for implementation, be declined, or if the idea requires additional analysis and/or details. If the idea should move forward, pursuing sponsorship 940 may include identifying and engaging a sponsor for the idea. Sponsorship might involve supporting the idea through resources, funding, guidance and/or endorsement of the suggested improvement to the workflow. The idea may then be implemented 950 by having the process owner track the progress of the idea as it progresses. A business lead may be identified and a scope statement associated with the changes may be developed.

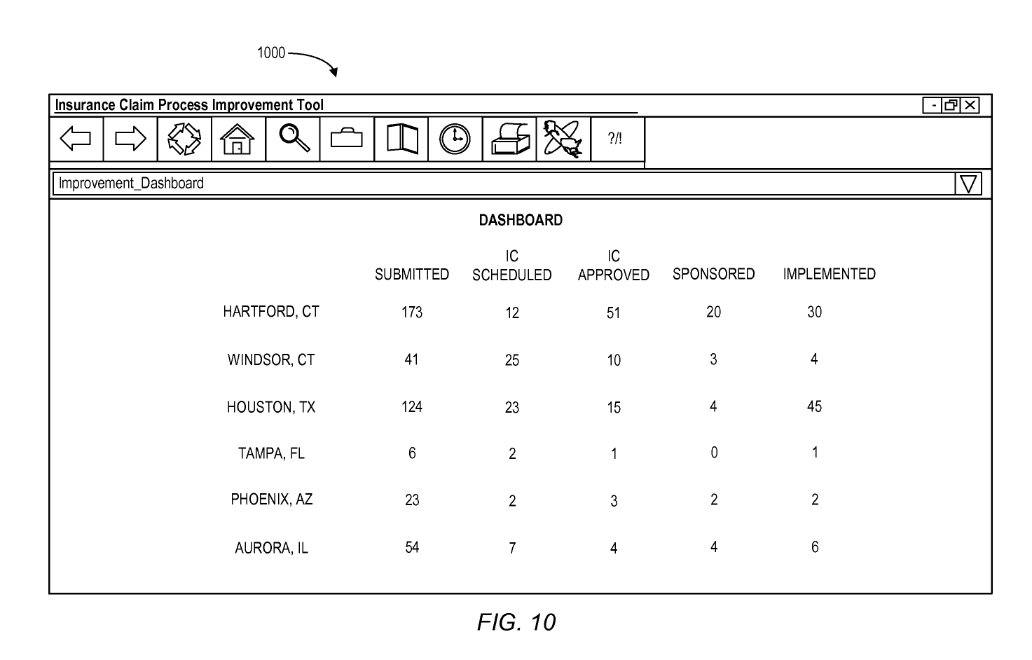

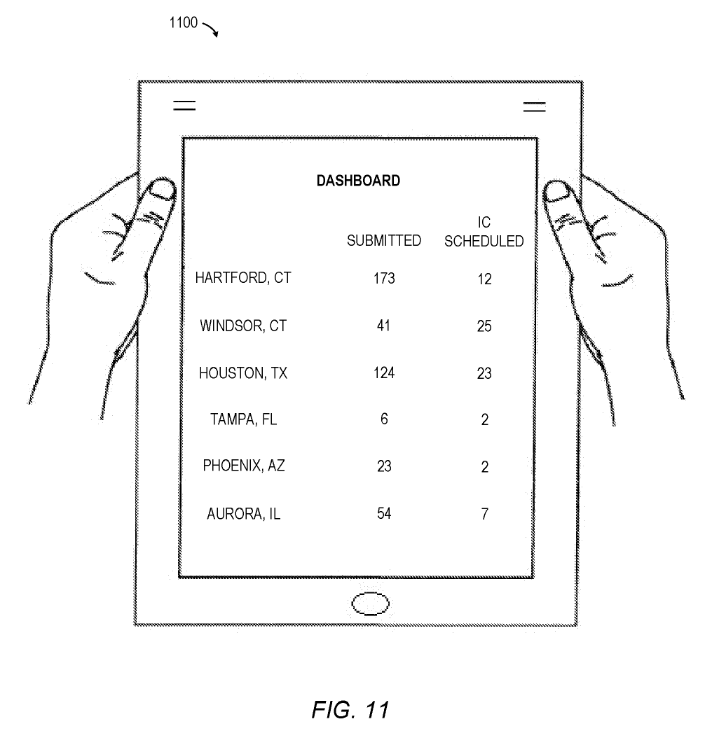

Thus, a submitted improvement to an insurance workflow will progress through various stages during the insurance workflow improvement process 900. To help track submissions, FIG. 10 illustrates an insurance workflow improvement dashboard interface 1000 according to some embodiments of the present invention. The dashboard interface 1000 displays, for a number of different processing sites, how many ideas have been submitted, are scheduled for innovation council review, have been approved by the innovation council, sponsored, and eventually implemented. Some embodiments, such as the dashboard interface 1000, have been described herein as being accessed via a PC or laptop computer. Note, however, that embodiments may be implemented using any device capable of executing the disclosed functions and steps. For example, FIG. 11 illustrates an interface 1100 for a mobile device in accordance with some embodiments described herein. In particular, the display 1100 includes a graphical user interface including information about suggested improvements to an insurance claim workflow.

Thus, embodiments may provide claim professionals with the tools they need to improve workflows. As a result, the quality of claim processing may be improved and/or productivity may be increased. Note that embodiments may help reduce different types of waste in an insurance workflow, including defects (e.g., data errors), transportation (moving physical files), motion (switching been applications), over-processing (multiple unneeded sign-offs), over-production (reports that go unread), inventory (filing cabinets filled with old documents), delay (waiting for return telephone calls), and/or behavioral (conflicting goals and objectives).

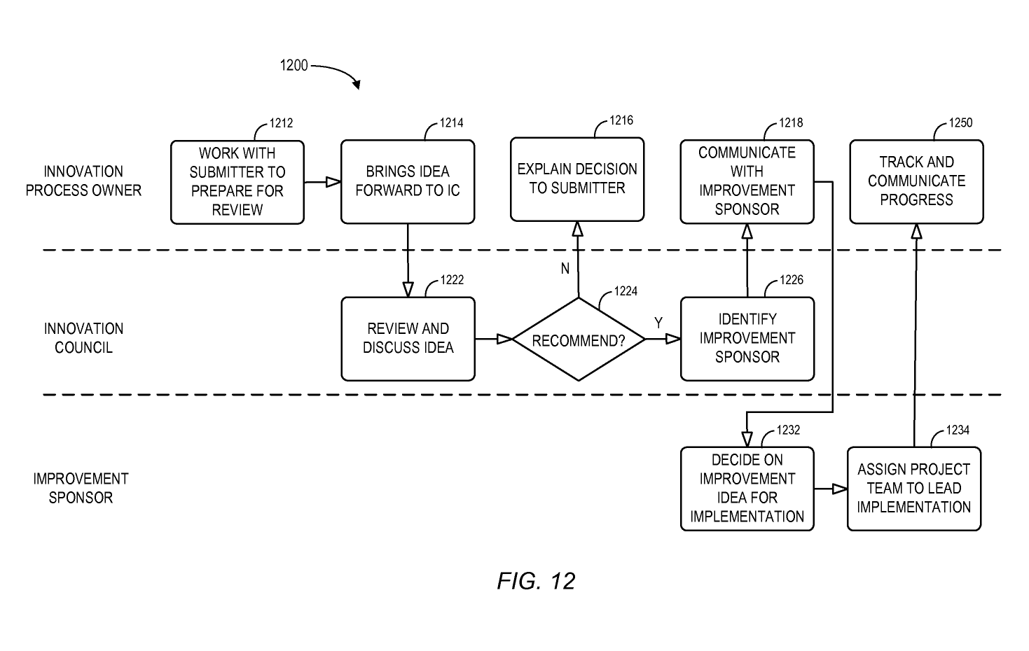

FIG. 12 illustrates an insurance workflow improvement process 1200 according to some embodiments of the present invention. At 1212, an innovation process owner may work with a submitter to prepare an idea to be reviewed. At 1214, the innovation process owner brings the idea forward to the innovation council, and the council may then review and discuss the idea at 1222. If the idea is not recommended by the council at 1224, the innovation process owner explains the decision to the submitter at 1216 and the process 1200 ends.

If the idea is recommended by the council at 1224, the council works to identify a sponsor for the idea at 1226. At 1218, the innovation process owner communicates with the improvement sponsor who may then decide how to implement the idea at 1232. The improvement sponsor may assign a project team to lead implementation of the idea at 1234, and the innovation may track progress and communicate with the original submitter at 1250 until the idea is implemented (and the insurance workflow has been improved).

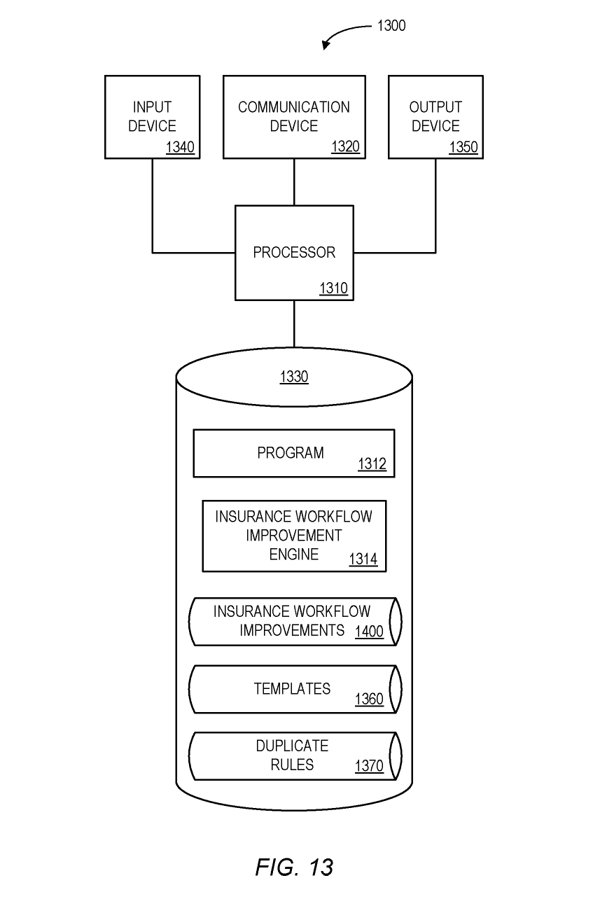

The embodiments described herein may be implemented using any number of different hardware configurations. For example, FIG. 13 is block diagram of an insurance workflow improvement tool or platform 1300 that may be, for example, associated with the system 100 of FIG. 1. The insurance workflow improvement platform 1300 comprises a processor 1310, such as one or more commercially available Central Processing Units (CPUs) in the form of one-chip microprocessors, coupled to a communication device 1320 configured to communicate via a communication network (not shown in FIG. 13). The communication device 1320 may be used to communicate, for example, with one or more remote devices (e.g., associated with claim professionals, managers, and/or members of an innovation council). The insurance workflow improvement platform 1300 further includes an input device 1340 (e.g., a mouse and/or keyboard to enter and adjust information about a submitted idea) and an output device 1350 (e.g., a computer monitor to display a graphical user interface and/or reports).

The processor 1310 also communicates with a storage device 1330. The storage device 1330 may comprise any appropriate information storage device, including combinations of magnetic storage devices (e.g., a hard disk drive), optical storage devices, mobile telephones, and/or semiconductor memory devices. The storage device 1330 stores a program 1312 and/or an insurance workflow improvement engine 1314 for controlling the processor 1310. The processor 1310 performs instructions of the programs 1312, 1314, and thereby operates in accordance with any of the embodiments described herein. For example, the processor 1310 may receive an indication of a suggested improvement to an insurance claim workflow from a submitter's remote insurance claim processing terminal. A manager associated with the submitter may be automatically identified, and the processor 1310 may transmit a message to the identified manager, including an identification of the submitter and information about the suggested improvement. The processor 1310 may then receive supplemental information associated with the suggested improvement from the manager to be stored along with the identification of the submitter and the indication of the suggested improvement. The indication of the suggested improvement and the supplemental information may then be automatically forwarded by the processor 1310 to a plurality of members comprising a suggestion review council.

The programs 1312, 1314 may be stored in a compressed, uncompiled and/or encrypted format. The programs 1312, 1314 may furthermore include other program elements, such as an operating system, clipboard application a database management system, and/or device drivers used by the processor 1310 to interface with peripheral devices.

As used herein, information may be “received” by or “transmitted” to, for example: (i) the insurance workflow improvement platform 1300 from another device; or (ii) a software application or module within the insurance workflow improvement platform 1300 from another software application, module, or any other source.

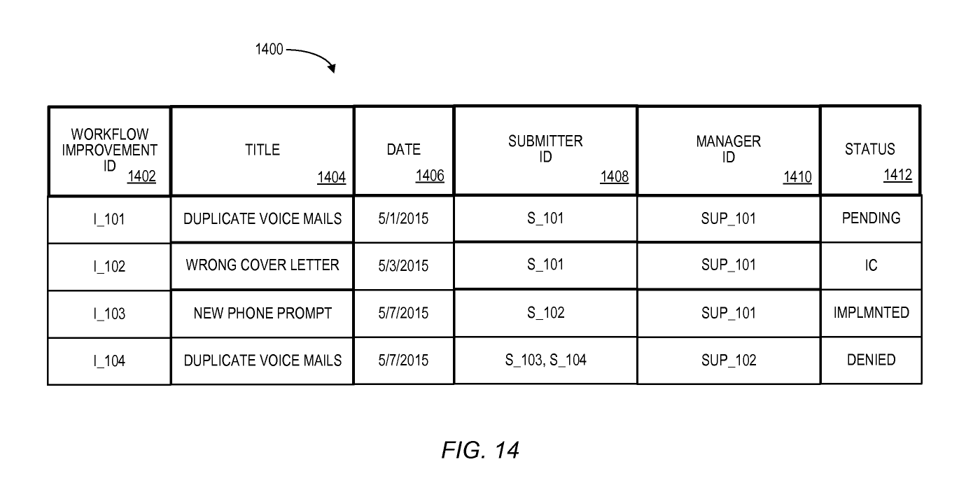

In some embodiments (such as shown in FIG. 13), the storage device 1330 further stores an insurance workflow improvements database 1400, templates 1360 (e.g., templates of how a benefits analysis should be formatted), and duplicate rules 1370 (e.g., rules that define when a submitted idea should be flagged as being the same as a previously submitted idea based on tags, keywords, language analysis, etc.). An example of a database that may be used in connection with the insurance workflow improvement platform 1300 will now be described in detail with respect to FIG. 14. Note that the database described herein is only one example, and additional and/or different information may be stored therein. Moreover, various databases might be split or combined in accordance with any of the embodiments described herein. For example, the templates 1360 and/or duplicate rules 1370 might be combined and/or linked to each other within the program 1312 and/or insurance workflow improvement engine 1314.

Referring to FIG. 14, a table is shown that represents the insurance workflow improvements database 1400 that may be stored at the insurance workflow improvement platform 1300 according to some embodiments. The table may include, for example, entries identifying workflow improvement ideas submitted by claim professionals. The table may also define fields 1402, 1404, 1406, 1408, 1410 for each of the entries. The fields 1402, 1404, 1406, 1408, 1410 may, according to some embodiments, specify: a workflow improvement identifier 1402, a title 1404, a date 1406, a submitter identifier 1408, a manager identifier 1410, and a status 1412. The insurance workflow improvements database 1400 may be created and updated, for example, based on information received from claim professionals, managers, and/or members of an innovation council.

The workflow improvement identifier 1402 may be, for example, a unique alphanumeric code identifying an idea to improve insurance claim processing. The title 1404 may describe the idea and the date 1406 may indicate when the idea was submitted. The submitter identifier 1408 may identify the claim profession who submitted the idea and the manager identifier 1410 may indicate his or her supervisor (who may, according to some embodiments, be asked to provide supplemental information about the suggested improvement). The status 1412 may indicate the current state of the submitted idea as it flows through the insurance workflow improvement program (e.g., the submitted idea might be pending, under review by the innovation council, implemented, denied, etc.).

Thus, embodiments described herein may provide insurance professionals with the ability to submit new ideas to improve an insurance workflow. Moreover, the submitted ideas can be reviewed, tracked, and/or prioritized in an automated and efficient manner.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Applicants have discovered that embodiments described herein may be particularly useful in connection with insurance claim processing workflows. Note, however, that other types of insurance workflows may also benefit from the invention (e.g., underwriting decisions).

According to some embodiments, an insurer may set forth a goal or “challenge” to a group of employees (e.g., to reduce claim processing time by ten minutes on average). The employees may then submit suggestions, review suggestions made by other employees, and/or provide comments (e.g., assign a rating) and/or changes to suggestions made by other employees. In this way, a collaborative approach may be employed to eventually identify one or more potential solutions and/or improvements.

According to other embodiments, employees of an insurer who deal with customers may have the ability to “flag” or otherwise mark points in an insurance process workflow when difficulties arise. For example, if a customer becomes confused by an explanation given during a telephone call, the employee can click an icon to indicate that interaction did not go smoothly (and perhaps provide a brief description of the problem). The insurer can collect and analyze these indications over a period of time to determine where an insurance workflow process may be improved.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system for facilitating insurance workflow improvements, comprising:
a communication device to receive, from a submitter's remote insurance processing terminal, an indication of a suggested improvement to an insurance workflow;
a computer processor for executing program instructions; and
a memory, coupled to the computer processor, for storing program instructions for execution by the computer processor for:
identifying a manager associated with the submitter,
transmitting a message to the identified manager, the message including an identification of the submitter and information about the suggested improvement;
receiving, from the manager, supplemental information associated with the suggested improvement,
storing the supplemental information at a central workflow improvement platform along with the identification of the submitter and the indication of the suggested improvement,
forwarding the indication of the suggested improvement and the supplemental information to one or more members comprising a suggestion review council, and
identifying a potential sponsor associated with the suggested improvement.

2. The system of claim 1, wherein the submitter is able to access a first portion of the supplemental information without being able to access a second portion.

3. The system of claim 1, wherein the memory further stores program instructions for execution by the computer processor for:
receiving an indication of approval from the suggestion review council, and
adjusting the insurance workflow in accordance with the suggested improvement.

4. The system of claim 1, wherein the memory further stores program instructions for execution by the computer processor for:
generating a report associated with a plurality of suggested improvements based at least in part on: (i) suggested improvement status, (ii) claims site, (iii) line of business, (iv) submitter, (v) date, and (vi) importance.

5. The system of claim 1, wherein the received indication of a suggested improvement to the insurance workflow includes at least two of: (i) an explanation of opportunity, (ii) an estimated impact of problem, (iii) a proposed solution, (iv) a primary improvement area, (v) an indication of involved individuals, (vi) a site, and (vii) a remote worker indication.

6. The system of claim 1, wherein the memory further stores program instructions for execution by the computer processor for:
assigning a process owner to the suggested improvement, and
receiving from the process owner at least two of: (i) a benefits calculation, (ii) a review date, (iii) an implementation date, (vi) a date of decline, (vii) action item descriptions, (viii) a sponsor identifier, (ix) a business lead, (x) a claims organization selection, (xi) a field department selection, (xii) a status, (xiii) a reason for closing, and (xiv) recognitions.

7. The system of claim 1, wherein the memory further stores program instructions for execution by the computer processor for:
analyzing a plurality of submitted improvements to identify potentially related submitted improvements.

8. The system of claim 1, wherein said analyzing comprises at least one of: (i) detecting redundant suggested improvements, (ii) categorizing suggested improvements, and (iii) detecting alternate suggested improvements.

9. The system of claim 1, wherein the memory further stores program instructions for execution by the computer processor for:
retrieving the supplemental information at the central workflow improvement platform along with the identification of the submitter the indication of the suggested improvement, and
transmitting the indication of the suggested improvement and the supplemental information to the potential sponsor.

10. A computer-implemented method for insurance workflow improvements, comprising:
receiving, from a submitter's remote insurance processing terminal, an indication of a suggested improvement to an insurance workflow;
automatically identifying a manager associated with the submitter;
automatically transmitting a message to the identified manager, the message including an identification of the submitter and information about the suggested improvement;
receiving, from the manager, supplemental information associated with the suggested improvement;
storing the supplemental information at a central workflow improvement platform along with the identification of the submitter and the indication of the suggested improvement; and
automatically forwarding the indication of the suggested improvement and the supplemental information to a plurality of members comprising a suggestion review council.

11. The method of claim 10, wherein the submitter is able to access a first portion of the supplemental information without being able to access a second portion.

12. The method of claim 10, further comprising:
receiving an indication of approval from the suggestion review council; and
adjusting the insurance workflow in accordance with the suggested improvement.

13. The method of claim 10, further comprising generating a report associated with a plurality of suggested improvements based at least in part on: (i) suggested improvement status, (ii) claims site, (iii) line of business, (iv) submitter, (v) date, and (vi) importance.

14. The method of claim 10, wherein the received indication of a suggested improvement to the insurance workflow includes at least two of: (i) an explanation of opportunity, (ii) an estimated impact of problem, (iii) a proposed solution, (iv) a primary improvement area, (v) an indication of involved individuals, (vi) a site, and (vii) a remote worker indication.

15. The method of claim 10, further comprising:
assigning a process owner to the suggested improvement; and
receiving from the process owner at least two of: (i) a benefits calculation, (ii) a review date, (iii) an implementation date, (vi) a date of decline, (vii) action item descriptions, (viii) a sponsor identifier, (ix) a business lead, (x) a claims organization selection, (xi) a field department selection, (xii) a status, (xiii) a reason for closing, and (xiv) recognitions.

16. A non-transitory computer-readable medium storing instructions adapted to be executed by a computer processor to perform a method for facilitating workflow improvements, said method comprising:
receiving, from a submitter's remote insurance claim processing terminal, an indication of a suggested improvement to an insurance claim workflow;
automatically identifying a manager associated with the submitter;
automatically transmitting a message to the identified manager, the message including an identification of the submitter and information about the suggested improvement;
receiving, from the manager, supplemental information associated with the suggested improvement;
storing the supplemental information at a central workflow improvement platform along with the identification of the submitter and the indication of the suggested improvement; and
automatically forwarding the indication of the suggested improvement and the supplemental information to one or more members comprising a suggestion review council.

17. The medium of claim 16, wherein the method further comprised:
automatically analyzing a plurality of submitted improvements to identify potentially related submitted improvements.

18. The medium of claim 16, wherein said analyzing comprises at least one of: (i) detecting redundant suggested improvements, (ii) categorizing suggested improvements, and (iii) detecting alternate suggested improvements.

19. The medium of claim 16, wherein the method further comprises:
automatically identifying a sponsor for the suggested improvement;
retrieving the supplemental information at the central workflow improvement platform along with the identification of the submitter the indication of the suggested improvement; and
transmitting the indication of the suggested improvement and the supplemental information to the sponsor.

20. The medium of claim 16, wherein the method further comprises:
assigning a process owner to the suggested improvement; and
receiving from the process owner at least two of: (i) a benefits calculation, (ii) a review date, (iii) an implementation date, (vi) a date of decline, (vii) action item descriptions, (viii) a sponsor identifier, (ix) a business lead, (x) a claims organization selection, (xi) a field department selection, (xii) a status, (xiii) a reason for closing, and (xiv) recognitions.
